(19) United States
(12) Patent Application Publication
(10) Pub. No.: US 2018/0161128 A1
(43) Pub. Date: Jun. 14, 2018

(54) Dental Implant And Abutment With Nanotube Arrays

(71) Applicant: Nasseo, Inc., San Jose, CA (US)

(72) Inventors: Garrett Cale SMITH, San Jose, CA (US); Kayvon POURMIRZAIE, San Jose, CA (US)

(73) Assignee: Nasseo, Inc., San Francisco, CA (US)

(21) Appl. No.: 15/577,798

(22) PCT Filed: Sep. 25, 2015
(86) PCT No.: PCT/US15/52452

§ 371 Date: Nov. 29, 2017

Related U.S. Application Data
(60) Provisional application No. 62/056,430, filed on Sep. 26, 2014.

(51) Int. Cl. A61C 8/00

(52) U.S. Cl. CPC A61C 8/0013; A61C 8/0024; A61C 8/0068; A61C 8/006; A61C 8/0025

(57) ABSTRACT

Disclosed herein are biocompatible dental implant systems comprising: an implant body comprising a top collar; and an abutment comprising a first coupling region and a second coupling region; wherein the first coupling region is mechanically coupled to the top collar, and the second coupling region is mechanically coupled to a crown, and wherein at least a portion of a surface of the abutment includes one or more nanotube arrays, the one or more nanotube arrays comprising a plurality of nanotubes separated by a plurality of empty spaces.

### CROSS-REFERENCE TO RELATED APPLICATIONS

This application claims the benefit of U.S. Provisional Application No. 62/056,430 filed Sep. 26, 2014, which is incorporated by reference herein in its entirety.

### BACKGROUND

Nano-scaled materials exhibit extraordinary electrical, optical, magnetic, chemical and biological properties, which cannot be achieved by micro-scaled or bulk counterparts.

### SUMMARY OF THE INVENTION

Disclosed herein are articles of manufacture comprising biocompatible nanostructures comprising nanotubes, nanopores, or arrays thereof for cell, tissue, or organ growth, uses thereof for in vitro testing or in vivo implant, and related diagnostic, screening, research, and therapeutic uses.

Nano-scaled materials exhibit extraordinary electrical, optical, magnetic, chemical and biological properties, which cannot be achieved by micro-scaled or bulk counterparts. The development of nano-scaled materials has been intensively pursued in order to utilize such properties for various technical applications including biomedical and biological applications.

Metals and alloys such as Ti and Ti alloys are corrosion resistant, light, yet sufficiently strong for load-bearing, and are machinable. They are one of the few biocompatible metals which osseo-integrate (osseo-integration is direct chemical or physical bonding with adjacent bone surface without forming a fibrous tissue interface layer). For these reasons, they have been used successfully as orthopedic and dental implants.

The structure of the anodized metal and/or alloy with nanotube arrays, such as the diameter, spacing and height of nanotubes, is not always easy to control during the electrochemical anodization process of pore formation. For example, the largest reported diameter of TiO2 nanotubes is less than approximately 100 nanometers (nm) to 150 nm. While a portion of filopodia, the thin branches of growing cells, can get into such a small pores and enhance cell adhesion/growth, the approximately 100 nm regime of dimension is too small to accommodate the main part of typical osteoblast and many other cells as these have a much larger dimension of micrometers. In addition, the desired insertion of biological agents such as biomolecular growth factors, cytokines, collagens, antibiotics, antibodies, drug molecules, small molecules, inorganic nanoparticles, etc. within the pores for further accelerated cell/bone growth or for medical therapeutics can be facilitated if the inner diameter of the pores is made somewhat larger. Therefore, an ability to artificially design and construct a biocompatible nanostructure, e.g., with a specific desired nanotube diameter, nanopore dimension and spacing, is desirable for further controlled and accelerated growth of bones and cells.

For orthopaedic and dental applications, a dual structure of larger dimension pores, which in one aspect can be of re-entrant shape, in combination of nanostructured surface would be desirable to have both accelerated cell/bone growth and physically locked-in bone configuration in the re-entrant large pores for improved mechanical durability on tensile or shear strain. Furthermore, if such a biocompatible nanostructure can be made to easily accommodate biological agent storage in the nano/micro pores to enhance multifunctional roles to additionally accelerate bone and cell growth, its practical usefulness can be much enhanced for various biomedical applications.

Coating of bioactive materials such as hydroxyapatite and calcium phosphate on Ti surface is a commonly used technique to make the Ti surface more bioactive for bone growth purposes. However, the fatal drawback of these currently available coating techniques is that such a flat and continuous coatings tend to fail by fracture or de-lamination at the interface between the implant and the coating as an adhesion failure, or at the interface between the coating and the bone, or at both boundary interfaces. Thick film coatings tends to introduce more interface stresses at the substrate-coating interface, especially in view of the lack of strong chemical bonding or the absence of common elements shared by the substrate (e.g., Ti implant) and the coating material. It would thus be desirable if the interface is bonded with an improved and integrated structure, for example, with a locked-in configuration with a much increased adhesion area, and as a discrete, less continuous layer to minimize interface stress and de-lamination.

The dental implant system, the manufacturing process, and methods described herein using nanotubes or nanotube arrays enable not only osseointegration but also soft tissue adhesion after implantation. Such tissue adhesion helps secure dental implant at the properly location, and enable a strong and sturdy foundation for the dental implant system. Other advantages associated with the dental implant system, the manufacturing process, and methods described herein are: decreasing or eliminating inflammatory responses, bacteria aggregation, infection, bone loss, and peri-implantitis, bone resorption, tissue loss, implant failure due to bone or tissue losses, and other possible side effects associated with traditional dental implantation. Additional advantages are: ability to deliver drug or protein at the dental implant system, ability to provide smooth dental implant surface or customized surface smoothness, capability to increase dental implant-to-tissue contact area, and ability to enable variability in nanotube pattern and array sizes to meet various need of different dental implant recipient.

In one aspect, disclosed herein, are biocompatible dental implant systems coated with nanotubes, comprising: an implant body comprising a top collar; an abutment comprising a first coupling region and a second coupling region; and a crown, wherein the first coupling region is mechanically coupled to the top collar, and the second coupling region is mechanically coupled to the crown, and wherein the abutment is coated at least partly by one or more nanotube arrays, the one or more nanotube arrays comprising: a plurality of nanotubes, each of the plurality of nanotubes comprising one or more selected from metal, metal oxide, alloy, and alloy oxide; and a plurality of empty spaces located between the plurality of nanotubes, wherein the one or more nanotube arrays are configured to directly contact hard tissue, soft tissue, or both when the dental implant system is properly implanted.

In another aspect, disclosed herein are biocompatible dental implant systems comprising: an implant body comprising a top collar; and an abutment comprising a first coupling region and a second coupling region; wherein the first coupling region is mechanically coupled to the top collar, and the second coupling region is mechanically coupled to a crown, and wherein at least a portion of a surface of the abutment includes one or more nanotube arrays, the one or more nanotube arrays comprising a plurality of nanotubes separated by a plurality of empty spaces.

In another aspect, disclosed herein, are methods of manufacturing a biocompatible dental implant system, comprising: anodizing a sample in a predetermined electrolyte solution, generating an anodized sample, comprising; connecting the sample to a negative electrode; connecting Platinum to a positive electrode; placing the positive and negative electrodes in the predetermined electrolyte solution; connecting the positive and negative electrodes to a power supply; and turning on the power supply; and heat-treating the anodized sample, generating a processed sample comprising a plurality of nanotubes separated by a plurality of empty spaces.

### BRIEF DESCRIPTION OF THE DRAWINGS

FIG. 1 illustrates a non-limiting example of anodization set up for generating a surface layer of nanotube arrays on top of a Ti sheet.

FIG. 2A shows a non-limiting example of the dental implant system as disclosed herein.

FIG. 2B shows a non-limiting example of the abutment as disclosed herein.

FIG. 3 shows a non-limiting example of the nanotube arrays as disclosed herein.

FIG. 4A shows another non-limiting example of the dental implant system as disclosed herein.

FIG. 4B shows a non-limiting example of the implant body as disclosed herein.

### DETAILED DESCRIPTION OF THE INVENTION

Disclosed herein, in various embodiments are biocompatible dental implant systems coated with nanotubes, comprising: an implant body comprising a top collar; an abutment comprising a first coupling region and a second coupling region; and a crown, wherein the first coupling region is mechanically coupled to the top collar, and the second coupling region is mechanically coupled to the crown, and wherein the abutment is coated at least partly by one or more nanotube arrays, the one or more nanotube arrays comprising: a plurality of nanotubes, each of the plurality of nanotubes comprising one or more selected from: a metal, a metal oxide, an alloy, an alloy oxide, and a polymer; and a plurality of empty spaces located between the plurality of nanotubes, wherein the one or more nanotube arrays are configured to directly contact hard tissue, soft tissue, or both when the dental implant system is properly implanted. In some embodiments, each of the plurality of nanotubes comprises a tubular wall; at least two ends; and a hollow inner space located between the two ends and enclosed by the tubular wall. In some embodiments, the one or more nanotube arrays are configured to directly contact at least the soft tissue when the dental implant system is properly implanted. In some embodiments, the tubular wall comprises one or more selected from: a metal, a metal oxide, an alloy, an alloy oxide, and a polymer. In some embodiments, the tubular wall comprises one or more selected from: Ti, Ta, Hf, Zr, Nb, W, TiAlNb, TiNb, and TiZr. In some embodiments, the tubular wall has a wall thickness of about 0.1 nanometer (nm) to about 1 micron. In some embodiments, the tubular wall is substantially vertical to a surface of the implant body, the abutment, or both. In some embodiments, the hollow inner space is configured to hold one or more biocompatible material for release. In some embodiments, the hollow inner space is configured to allow cell growth. In some embodiments, the plurality of nanotubes and the plurality of empty spaces located between the plurality of nanotubes are aligned in a repetitive pattern. In some embodiments, the repetitive pattern occurs in a plane vertical to a surface of the implant body, the abutment, or both. In some embodiments, the repetitive pattern occurs in two dimensions or three dimensions. In some embodiments, the plurality of nanotubes comprises one or more selected from: Ti, Ta, Hf, Zr, Nb, W, TiAlNb, TiNb, and TiZr. In some embodiments, the coating of the implant body, the abutment, or both by one or more nanotube arrays is at a surface of the implant body, the abutment, or both. In some embodiments, the plurality of nanotubes is substantially vertically aligned with respect to a surface of the implant body, the abutment, or both. In some embodiments, the depth of the tubular wall vertical to a surface of the implant body, the abutment, or both is in the range of about 1 nanometers (nm) to about 10 microns. In some embodiments, a diameter of a horizontal cross-sectional area of each of the nanotubes is in the range of about 1 nanometer (nm) to about 1 micron. In some embodiments, the width and length in a horizontal direction of each of the plurality of empty spaces between the plurality of nanotubes is in the range of about 1 nanometer (nm) to about 1 micron. In some embodiments, the plurality of empty spaces between the plurality of nanotubes is configured to hold one or more selected from: a biocompatible material or a biological material for release. In some embodiments, the one or more nanotube arrays further comprises a polymer layer. In some embodiments, the one or more nanotube arrays are on a top surface of a polymer layer of the abutment. In some embodiments, the polymer layer is configured to facilitate the release of one or more selected from: a biocompatible material or a biological material. In some embodiments, the polymer layer is configured to facilitate the release of one or more of a biocompatible material or a biological material. In some embodiments, the plurality of empty spaces between the plurality of nanotubes is configured to allow cell growth. In some embodiments, the abutment is mechanically coupled to the crown on a side opposite to the top collar. In some embodiments, the implant body is tapered. In some embodiments, the implant body is configured to enable platform switching. In some embodiments, the abutment is customized. In some embodiments, the abutment is screw-retained. In some embodiments, the one or more nanotube arrays are generated via an anodization process of one or more of a metal, a metal oxide, an alloy, an alloy oxide, and a polymer. In some embodiments, the one or more nanotube arrays are generated via a heat-treating process of one or more of a metal, a metal oxide, an alloy, an alloy oxide, and a polymer. In some embodiments, the first or the second coupling region comprises a screw, a hex a threading, a hex, a flute, a groove, a recess, a notch, and a protrusion. In some embodiments, the top collar comprises a screw. In some embodiments, the one or more nanotube arrays are configured to facilitate or generate one or more selected from: soft tissue adhesion to the dental implant system, delivery of one or more biocompatible material, increased implant-to-tissue contact area, and variability of nanotube arrays. In some embodiments, the one or more nanotube arrays are configured to decrease or eliminate one or more selected from: inflammatory response, bacteria aggregation, infection, bone loss, peri-implantitis, bone resorption, tissue loss, and implant failure. In some embodiments, the abutment is coated by the nanotube arrays covering at least a region underneath the second coupling region where the crown attaches to. In some embodiments, the abutment is coated by the nanotube arrays covering about 80%, 90% or, 99% of a surface thereof. In some embodiments, the surface is in contact with hard tissue, soft tissue, or both when the dental implant system is properly implanted. In some embodiments, the surface is the entire outer surface of the abutment. In some embodiments, the one or more nanotube arrays are configured to directly contact at least the soft tissue when the dental implant system is properly implanted.

Disclosed herein, in various embodiments, are biocompatible dental implant systems comprising: an implant body comprising a top collar; and an abutment comprising a first coupling region and a second coupling region; wherein the first coupling region is mechanically coupled to the top collar, and the second coupling region is mechanically coupled to a crown, and wherein at least a portion of a surface of the abutment includes one or more nanotube arrays, the one or more nanotube arrays comprising a plurality of nanotubes separated by a plurality of empty spaces. In some embodiments, each of the plurality of nanotubes comprises a tubular wall; at least two ends; and a hollow inner space located between the two ends and enclosed by the tubular wall. In some embodiments, the tubular wall comprises one or more selected from: a metal, a metal oxide, an alloy, an alloy oxide, and a polymer. In some embodiments, the tubular wall comprises one or more selected from: Ti, Ta, Hf, Zr, Nb, W, TiAlNb, TiNb, TiZr, and Polyether ether ketone (PEEK). In some embodiments, the tubular wall has a wall thickness of about 0.1 nm to about 1 micron. In some embodiments, the tubular wall is substantially vertical to a surface plane of the implant body, the abutment, or both. In some embodiments, the hollow inner space is configured to hold one or more biocompatible material, to release one or more biocompatible material, or both.

In some embodiments, the hollow inner space is configured to allow cell growth. In some embodiments, the depth of the tubular wall vertical to a surface plane of the implant body, the abutment, or both is in the range of about 1 nanometer (nm) to about 10 microns. In some embodiments, the one or more nanotube arrays are configured to directly contact at least a soft tissue when the biocompatible dental implant system is properly implanted. In some embodiments, the plurality of nanotubes and the plurality of empty spaces are aligned in a repetitive pattern. In some embodiments, the repetitive pattern occurs in a plane vertical to a surface plane of the implant body, the abutment, or both. In some embodiments, the repetitive pattern occurs in two dimensions or three dimensions. In some embodiments, the plurality of nanotubes comprises one or more selected from: Ti, Ta, Hf, Zr, Nb, W, TiAlNb, TiNb, TiZr, and PEEK. In some embodiments, the plurality of nanotubes is substantially vertically aligned with respect to a surface plane of the implant body, the abutment, or both. In some embodiments, a diameter of a horizontal cross-sectional area of each of the plurality of nanotubes is in the range of about 1 nm to about 1 micron. In some embodiments, the width and length in a horizontal direction of each of the plurality of empty spaces is in the range of about 1 nanometer (nm) to about 1 micron. In some embodiments, the plurality of empty spaces is configured to hold one or more selected from: a biocompatible material or a biological material for release. In some embodiments, the one or more nanotube arrays are on a top surface of a polymer layer of the abutment. In some embodiments, the polymer layer is configured to facilitate the release of one or more selected from: a biocompatible material and a biological material. In some embodiments, the plurality of empty spaces between the plurality of nanotubes is configured to allow cell growth. In some embodiments, the abutment is mechanically coupled to the crown on a side opposite to a side of the top collar. In some embodiments, the implant body is tapered. In some embodiments, the implant body is configured to enable platform switching. In some embodiments, the abutment is customized. In some embodiments, the abutment is screw-retained. In some embodiments, the one or more nanotube arrays are generated via an anodization process of one or more selected from: a metal, a metal oxide, an alloy, an alloy oxide, and a polymer. In some embodiments, the one or more nanotube arrays are generated via a heat-treating process of one or more selected from: a metal, a metal oxide, an alloy, an alloy oxide, and a polymer. In some embodiments, any of the first and the second coupling regions comprises one or more selected from: a screw, a threading, a hex, a groove, a recess, a notch, and a protrusion. In some embodiments, the top collar comprises a screw. In some embodiments, the one or more nanotube arrays are configured to facilitate or generate one or more selected from: soft tissue adhesion to the biocompatible dental implant system, delivery of one or more biocompatible materials, and increased implant-to-tissue contact area. In some embodiments, the one or more nanotubc arrays are configured to decrease or eliminate one or more selected from: inflammatory response, bacteria aggregation or colonization, infection, bone loss, peri-implantitis, bone resorption, tissue loss, and implant failure. In some embodiments, the one or more nanotube arrays cover at least a region underneath the second coupling region the crown attaches thereto. In some embodiments, the portion of the surface is any of about 10%, about 20%, about 30%, about 40%, about 50%, about 60%, about 70%, about 80%, about 90%, and about 100%. In some embodiments, the portion of the surface is in contact with hard tissue, soft tissue, or both when the biocompatible dental implant system is properly implanted. In some embodiments, the plurality of nanotubes comprises one or more selected from: a metal, a metal oxide, an alloy, an alloy oxide, and a polymer.

Disclosed herein, in various embodiments, are methods of manufacturing a biocompatible dental implant system, comprising: anodizing a sample in a predetermined electrolyte solution, generating an anodized sample, comprising; connecting the sample to a negative electrode; connecting Platinum to a positive electrode; placing the positive and negative electrodes in the predetermined electrolyte solution; connecting the positive and negative electrodes to a power supply; and turning on the power supply; and heat-treating the anodized sample, generating a processed sample comprising a plurality of nanotubes separated by a plurality of empty spaces. In some embodiments, the sample comprises one or more selected from: a metal, a metal oxide, an alloy, an alloy oxide, and a polymer. In some embodiments, the sample comprises one or more selected from: Ti, Ta, Hf, Zr, Nb, W, TiAlNb, TiNb, and TiZr. In some embodiments, the power supply is about 5 Volts to about 100 Volts. In some embodiments, the power supplied is turned on for at least about 1 minute to about 60 minutes. In some embodiments, the heat-treating is at a temperature in the range of about 250 degrees Celsius to about 350 degrees Celsius. In some embodiments, the heat-treating lasts for at least about 3 hours to about 24 hours. In some embodiments, the method further comprises manufacturing the processed sample to generate an implant body, an abutment, or both of the biocompatible dental implant system. In some embodiments, the sample is an implant body, an abutment, or both of a biocompatible dental implant system. In some embodiments, the abutment is mechanically coupled to the crown on a side opposite to a side of the top collar. In some embodiments, the implant body is tapered. In some embodiments, the implant body is configured to enable platform switching. In some embodiments, the abutment is customized. In some embodiments, the abutment is screw-retained. In some embodiments, the method further comprises sonicating the sample. In some embodiments, the method further comprises rinsing the processed sample. In some embodiments, the method further comprises anodizing the sample in a second electrolyte solution, generating a second anodized sample comprising: connecting the sample to a negative electrode; connecting Platinum to a positive electrode; placing the positive and negative electrodes in the predetermined electrolyte solution; connecting the positive and negative electrodes to the power supply; and turning on the power supply, wherein a surface portion of the second anodized sample is removed using an adhesive material. In some embodiments, the anodizing in the second electrolyte solution occurs before the anodizing in the predetermined electrolyte solution. In some embodiments, the plurality of nanotubes, the plurality of empty spaces, or both are configured to directly contact at least a soft tissue when the biocompatible dental implant system is properly implanted. In some embodiments, each of the plurality of nanotubes comprises a tubular wall; at least two ends; and a hollow inner space located between the two ends and enclosed by the tubular wall. In some embodiments, the tubular wall comprises one or more selected from: a metal, a metal oxide, an alloy, an alloy oxide, and a polymer. In some embodiments, the tubular wall comprises one or more selected from: Ti, Ta, Hf, Zr, Nb, W, TiAlNb, TiNb, TiZr, and PEEK. In some embodiments, the tubular wall has a wall thickness of about 0.1 nanometer (nm) to about 1 micron. In some embodiments, the tubular wall is substantially vertical to a surface plane of an implant body, an abutment, or both. In some embodiments, the hollow inner space is configured to hold one or more biocompatible material, to release one or more biocompatible material, or both. In some embodiments, the hollow inner space is configured to allow cell growth. In some embodiments, the depth of the tubular wall vertical to a surface plane of an implant body, an abutment, or both is in the range of about 1 nanometer (nm) to about 10 microns. In some embodiments, the plurality of nanotubes and the plurality of empty spaces are aligned in a repetitive pattern. In some embodiments, the repetitive pattern occurs in a plane vertical to a surface plane of the implant body, the abutment, or both. In some embodiments, the repetitive pattern occurs in two dimensions or three dimensions. In some embodiments, the plurality of nanotubes comprises one or more selected from: Ti, Ta, Hf, Zr, Nb, W, TiAlNb, TiNb, TiZr, and PEEK. In some embodiments, the plurality of nanotubes is substantially vertically aligned with respect to a surface plane of the implant body, the abutment, or both. In some embodiments, a diameter of a horizontal cross-sectional area of each of the plurality of nanotubes is in the range of about 1 nm to about 1 micron. In some embodiments, the width and length in a horizontal direction of each of the plurality of empty spaces is in the range of about 1 nm to about 1 micron. In some embodiments, the plurality of empty spaces configured to hold one or more selected from: a biocompatible material and a biological material for release. In some embodiments, the one or more nanotube arrays are on a top surface of a polymer layer of the abutment. In some embodiments, the polymer layer is configured to facilitate the release of one or more selected from: a biocompatible material or a biological material. In some embodiments, the plurality of empty spaces between the plurality of nanotubes is configured to allow cell growth. In some embodiments, the plurality of nanotubes, the plurality of empty spaces, or both are configured to facilitate or generate one or more selected from: soft tissue adhesion to the biocompatible dental implant system, delivery of one or more biocompatible material, and increased implant-to-tissue contact area. In some embodiments, the plurality of nanotubes, the plurality of empty spaces, or both are configured to decrease or eliminate one or more selected from: inflammatory response, bacteria aggregation, infection, bone loss, peri-implantitis, bone resorption, tissue loss, and implant failure. In some embodiments, the plurality of nanotubes, the plurality of empty spaces, or both are configured to directly contact hard tissue, soft tissue, or both when the biocompatible dental implant system is properly implanted. In some embodiments, the plurality of nanotubes comprises one or more selected from a metal, a metal oxide, an alloy, an alloy oxide, and a polymer. In some embodiments, the sample is an implant body, an abutment, or both of a biocompatible dental implant system.

### Overview

The dental implant system, the manufacturing process, and methods described herein using nanotubes or nanotube arrays enable not only osseointegration but also soft tissue adhesion after implantation. Such tissue adhesion helps secure dental implant at the properly location, and enable a strong and sturdy foundation for the dental implant system. Other advantages associated with the dental implant system, the manufacturing process, and methods described herein are: decreasing or eliminating inflammatory responses, bacteria aggregation, infection, bone loss, and peri-implantitis, bone resorption, tissue loss, implant failure due to bone or tissue losses, and other possible side effects associated with traditional dental implantation. Additional advantages are: ability to deliver drug or protein at the dental implant system, ability to provide smooth dental implant surface or customized surface smoothness, capability to increase dental implant-to-tissue contact area, and ability to enable variability in nanotube pattern and array sizes to meet various need of different dental implant recipient.

The dental implant system, the manufacturing process, and methods described herein includes nanotube array(s) at the abutment and optionally at least a portion of the implant body, for at least a portion of the abutment. Further, the nanotube array(s) are in direct contact with the soft tissue and optionally the bone when the implant system is properly implanted in a recipient. Yet further, the nanotube array(s) of the dental implant system is configured to facilitate soft tissue integration via their direct contact with the soft tissue and optional delivery of drug, protein, and/or other biocompatible materials to the surrounding tissue. Specifically, the nanotube array(s) enable tissue growth in a direct that is parallel to the longitudinal axis of the implant system, and/or other possible directions that secure the implant such that inflammatory responses, infection, and other possible side effects caused by the implantation are optimally minimized.

### Nanotube Patterns

In some embodiments, nanotubes (NTs) are applied to different types of implants. In further embodiments, nanotubes are applied to bone level implants or tissue level implants. In some embodiments, nanotubes are applied to cover any percentage of the entire volume or entire surface of the implants. In further embodiments, the percentage includes any number in between about 0.1% to about 99.9%. In some embodiments, nanotubes are applied within implants. In some embodiments, nanotubes are applied on at least part of the internal coupling regions or connection of the implant. In further embodiments, the internal coupling or connection connects the implant to one or more selected from: an abutment, a crown, an implant, a coating, and a human tissue structural.

In some embodiments, nanotubes are applied to different types of abutments. In some embodiments, nanotubes are applied to cover any percentage of the entire volume or surface of an abutment. In further embodiments, the percentage includes any number in between about 0.1% to about 99.9%. In some embodiments, nanotubes are placed on the bottom, the top, or both of an abutment.

In some embodiments, nanotubes include various patterning such that the NTs are only on at least a portion of an implant or at least a portion of an abutment.

In some embodiments, the nanotubes are substantially vertical to the surface area underneath the bottom end of the nanotubes. In some embodiments, the nanotubes are substantially horizontal to the surface plane underneath the bottom end of the nanotubes. In other embodiments, the nanotubes are substantially tilted with respect to the surface plane underneath the bottom end of the nanotubes. In further embodiments, the acute titled angle is in the range of about 1 degree to about 89 degrees. In some embodiments, the surface plane underneath the bottom end of the nanotubes is one or more selected from: the abutment, the implant body, and the crown. In some embodiments, the nanotubes and the spacing therebetween are substantially parallel.

### Materials of the Nanotubes

In some cases, NTs can be created or directly etched into any material. In further embodiments, NTs can be created in any metal or alloy. In further embodiments, NTs can be created in any metal or alloy with a metal oxide layer or alloy oxide layer. In further embodiments, non-limiting exemplary material includes one or more selected from: a metal, an alloy, a metal oxide, an alloy oxide, any material with an oxide layer, Titanium, Titanium alloy, Zirconia, Zirconium, ZrO₂, Trabecular metal, Tantalum oxide, a polymer with a layer of metal or an oxide layer placed on the polymer, a polymer, Carbon, cobalt chromium, Ta, Hf, Zr, Nb, W, TiAlNb, TiNb, TiZr, CP4, CP4 Ti, and Polyether ether ketone (PEEK).

### Implant Bodies

In some embodiments, the implant body includes one or more selected from: a metal, an alloy, a metal oxide, an alloy oxide, any material with an oxide layer, Titanium, Titanium alloy, Zirconia, Zirconium, ZrO₂, Trabecular metal, Tantalum oxide, a polymer with a layer of metal or an oxide layer placed on the polymer, a polymer, Carbon, cobalt chromium, commercially pure Ti, CP4, Ta, Hf, Zr, Nb, W, TiAlNb, TiNb, TiZr, and Polyether ether ketone (PEEK). In some embodiments, the implant body has a diameter of about 3.5 millimeters (mm), about 4.3 mm, or about 5.0 mm. In some embodiments, the implant body has a diameter ranging from about 2 mm to about 7.0 mm. In some embodiments, the implant body has a length of about 8 mm, about 10 mm, 11.5 mm or about 13 mm. In some embodiments, the implant body has a length ranging from about 5 mm to about 18 mm. In some embodiments, the diameter of the implant body is the average diameter, the maximal diameter, or the minimal diameter of all the cross-sectional diameters of the implant body.

In some embodiments, the implant body as disclosed herein is a tapered implant body. In some embodiments, the implant body is a self-tapping tapered implant body. In certain embodiments, a self-tapping tapered dental implant body is one that is threaded into a pre-drilled hole in a jaw bone without pre-tapping the hole. The end portion of the implant body itself taps the hole as the implant body is pressed into the pre-drilled hole and rotated. The implant body is tapered in the longitudinal direction to have progressively changing radii. A self-tapping implant body is for installation in living bone and has a cylindrical body with a threaded outer surface for securing the implant body to the walls of a preformed hole in bone. The top portion of the implant body attaches to tool for insertion and has connection for coupling with abutment for attachment to prosthesis.

In some embodiments, the implant body as disclosed herein includes a cover screw. In some embodiments, the cover screw includes nanotubes or at least a nanotube array. In further cases, the nanotubes or nanotube array facilities integration between the dental implant and the hard and/or soft tissue. In some embodiments, the cover screw is attached to the flush with the top of the implant body to be completely covered by mucosa to allow for integration of the endosseous implant body.

In some embodiments, the cover screw is threaded into the inner threads of the endosseous implant body. In some embodiments, the cover screw has a height or a diameter to match the inner thread design of the endosseous implant body and allow it to sit flush with the top of the implant.

In some embodiments, one or more features of the implant body or portions thereof include one or more nanotube arrays. In some embodiments, the feature(s) of the implant body that is in contact with a tissue include one or more nanotube arrays. In further embodiments, the feature(s) of the implant body that is in contact with a tissue include one or more nanotube arrays at least at a surface.

In some embodiments, nanotubes cover any percentage of the entire volume or entire surface of the implant body. In further embodiments, the percentage includes any number in between about 0.1% to about 99.9%. In some embodiments, the nanotubes or nanotube array covers at least about 10%, about 20%, about 30%, about 40%, about 50%, about 60%, about 70%, about 80%, about 90%, or about 99% of the surface area of the implant body. In further embodiments, the surface is in contact with the tissue. In alternative embodiments, the surface is the entire surface of the implant body.

In some embodiments, an implant body as disclosed herein includes one or more features selected from: tapered design, platform switching, internal hex, a micro-thread near the top collar, at least two varying types of micro-threads with different spacing in between each of them near the top collar, larger and thicker threads below the top collar and to bottom of implant body, back-tapered top collar, reverse-cutting flutes, and reverse-cutting flutes on opposite sides of the implant body near the bottom.

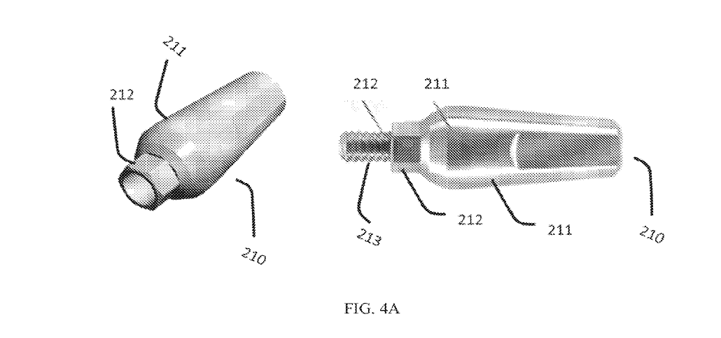

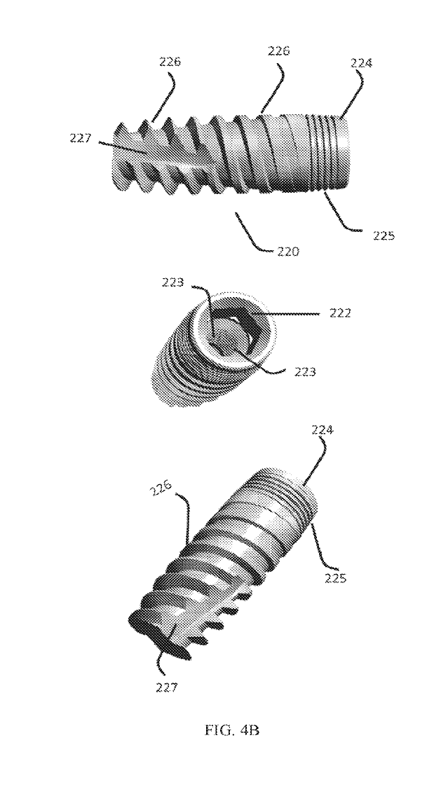

Referring to FIG. 4B, in a particular embodiment, an endosseous implant body 220 as disclosed herein is shown. In this embodiment, the implant body 220 includes a platform switching 224 for coupling to an abutment. In the same embodiments, the implant body includes micro threads 225, tapered thread 226, and cutting flute 227 for securing implant body to the hard tissue and for interfacing with the surrounding hard tissue. In this embodiment, the internal hex interface 222 and the internal screw threads 223 are optionally designed to receive the internal hex and the internal screw of an abutment. Such interface of the hex 222 and the screw 223 is configured to securely interface the implant body to the abutment.

### Abutments

In some embodiments, the abutment as disclosed herein includes one or more materials selected from: titanium, titanium alloy, zirconia, zirconium, ceramics, a metal, an oxide, a polymer, commercially pure type 4 Titanium (CP4 Ti), cobalt chromium, commercially pure Ti, Ta, Hf, Zr, Nb, W, TiAlNb, TiNb, TiZr, polymer, and PEEK. In some embodiments, the abutment includes one or more types selected from: screw retained, cement retained, healing, casting, impression, temporary, and esthetic. In some embodiments, the abutment is straight, angled, or customized abutment. In some embodiments, the abutment length is about 9 mm or about 10 mm. In further embodiments, the abutment length is about 9 mm for the about 3.5 mm diameter of the implant body. In alternative cases, the abutment length is about 10 mm for the about 4.3 mm diameter or about 5.0 mm diameter of the implant body. In some embodiments, the abutment length is 9 mm for the implant body whose diameter ranges from about 3 mm to about 4.2 mm. In some embodiments, the abutment length is about 10 mm for the implant body whose diameter ranges from about 4.3 mm to about 6 mm. In some embodiments, nanotubes (NTs) are placed on different types of abutments. In some embodiments, nanotubes are placed on one or more selected from: healing abutment, customized abutment, and abutments from custom 3D printing machines or robotic systems. In some embodiments, nanotubes cover any percentage of the entire volume or surface of the abutment. In further embodiments, the percentage includes any number in between about 0.1% to about 99.9%. In yet further cases, the nanotubes or nanotube array cover at least the region that is in close vicinity (as a non-limiting example, about 0 mm to about 5 mm) to the top collar of the implant body. In some embodiments, the nanotubes or nanotube array cover at least a basal region of the abutment. In further embodiments, the basal region of the abutment is below the second coupling region that is in attachment with the crown when the implant system is properly inserted. In some embodiments, the nanotubes or nanotube array covers at least about 10%, about 20%, about 30%, about 40%, about 50%, about 60%, about 70%, about 80%, about 90%, or about 99% of the surface of the abutment. In some embodiments, the surface of the abutment is the surface in contact with the tissue. In alternative embodiments, the surface is the entire surface of the abutment.

In some embodiments, the abutment disclosed herein is a healing abutment. In some embodiments, the healing abutment is made of one or more selected from: commercially pure Ti, titanium, titanium alloy, zirconia, zirconium, ceramics, a metal, an oxide, a polymer, CP4, CP4 Ti, cobalt chromium, Ta, Hf, Zr, Nb, W, TiAlNb, TiNb, TiZr, polymer, and PEEK. In some embodiments, the healing abutment is of various heights including but not limited to about 3 mm or about 5 mm. In some embodiments, the healing abutment is threaded to fit into an implant body. In some embodiments, the abutment is covered with nanotubes to enable soft tissue healing and create healthy tissue pocket for abutment placement.

In some embodiments, the abutment includes one or more coupling regions to couple one or more selected from: an implant body, a crown, a screw, a hex, a thread, and any other elements that is mechanically supported by the abutment. In some embodiments, the coupling at the one or more coupling regions is reversibly detachable.

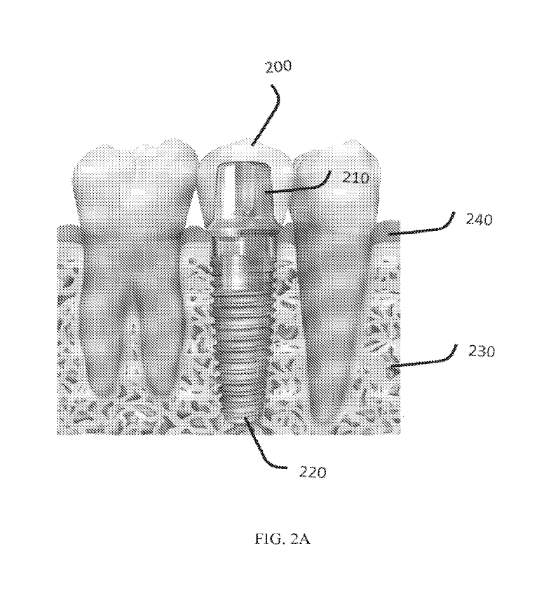

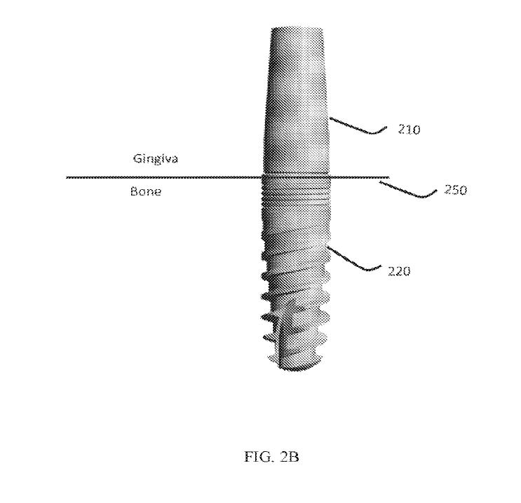

Referring to FIG. 2A, in a particular embodiment, the dental implant system as disclosed herein is properly implanted into a receipt. The abutment 210 is coupled to the crown 200 and the implant body 220. The nanotube arrays of the abutment are in direct contact with the hard tissue or bone structures 230 and/or soft tissue 240. The nanotube arrays of the implant body 220 are optionally in contact with the hard tissue or bone 230 and/or soft tissue 240.

Referring to FIG. 2B, in a particular embodiment, the abutment 210 and the implant body 220 is in a coupled configuration. In this embodiment, the nanotube arrays or the nanotubes of the abutment 210 are in direct contact with the bone and/or gingiva. In the same embodiments, the nanotube arrays or the nanotubes of the implant body 220 are optionally in contact with the bone/hard tissue and/or soft tissue. Optionally, in this embodiment, the proximate separation between bone and gingiva/soft tissue is shown as 250.

Referring to FIG. 4A, in a particular embodiment, the abutment 210 is shown. In this embodiment, a three-dimensional view of the abutment 210 is shown in the left panel. In the same embodiment, the abutment 210 optionally includes a straight abutment region 211, an internal hex 212, and an internal screw 213. In this case, the internal hex 212 and internal screw 213 are optionally configured to securely couple to an implant body. In this case, the nanotubes or nanotube arrays optionally cover at least a portion of the outer surface of the abutment 210 and at least a portion of the implant body 220.

### Drug Delivery and Protein Delivery

In some cases, the nanotube is loaded with at least one type of drug to be delivered to globally or locally to the dental implant recipient. In further embodiments, the drug is delivered from the nanotube up to a predetermined period of time. In some embodiments, the predetermined period time is about 2 hours, about 6 hours about 12 hours, about 1 day, about 2 days, about 3 days, about 4 days, or about 10 days. In some cases, the predetermined period time is within the range of about 1 hour to about 6 months. In further embodiments, the drug is delivered with a predetermined dose or rate. In some embodiments, the nanotube geometry is specifically designed to enable pre-specified drug delivery schemes. In some cases, the nanotube includes a polymer layer, which independently or together with the nanotube geometry determines the drug delivery schemes.

In some cases, the drug is loaded to the nanotubes before dental implantation, during dental implantation, or after dental implantation. Non-limiting examples of methods to load nanotubes includes vacuuming, pipetting, or lyophilization. Non-limiting examples of drugs includes Vancomyocin (dosage=500 ug/cm2), Gentamicin, Ibuprofen, and Cisplatin.

In some cases, the nanotube is loaded with at least one type of protein to be delivered to globally or locally to the dental implant recipient. In further embodiments, the protein is delivered from the nanotube to the dental implant recipient up to a predetermined period of time. In some embodiments, the predetermined period time is about 2 hours, about 6 hours about 12 hours, about 1 day, about 2 days, about 3 days, about 4 days, or about 10 days. In some cases, the predetermined period time is within the range of about 1 hour to about 6 months. In further embodiments, the protein is delivered with a predetermined dose or rate. In some embodiments, the nanotube geometry is specifically designed to enable pre-specified protein delivery schemes. In some cases, the nanotube includes a polymer layer, which independently or together with the nanotube geometry determines the protein delivery schemes.

In some cases, the at least one type of protein is loaded to the nanotubes before dental implantation, during dental implantation, or after dental implantation. Non-limiting examples of methods to load nanotubes includes vacuuming, pipetting, or lyophilization. Non-limiting examples of proteins includes amino acid sequence Arg-Gly-Asp recombinant human bone morphogenetic protein-2 (rhBMP-2), anti-microbial peptides (AMP). AMPs have also been referred to as cationic host defense peptides, anionic antimicrobial peptides/proteins, cationic amphipathic peptides, cationic AMPS, host defense peptides, and α-helical antimicrobial peptides.

### Benefits of Nanotubes for Dental Implant

In some embodiments, nanotubes included in at least a portion of the dental implant reduce the severity or decrease the rate of incidence of one or more complications or adverse events that may associate with conventional dental implantations: peri-implantitis, inflammation, bone resorption, bone loss, tissue loss, and implant failure due to bone or tissue losses.

In some embodiments, nanotubes of the dental implant promote hard tissue attachment and osseointegration. In further cases, nanotubes of the dental implant provides a large surface area, increase bone-to-implant contact area, or stimulate in-growth of bone into the nanotubes. In some cases, nanotubes of the dental implant promote soft tissue attachment. As a result, in further cases, the nanotubes thereby creates a bacterial seal near implant/abutment connection that mimics natural tooth and prevents bacteria from going down into the implant and causing inflammation. In some embodiments, nanotubes of the dental implant prevent bacterial adhesion, aggregation, or colonization. In some embodiments, nanotubes of the dental implant prevent biofilm adhesion, aggregation, or colonization. In some embodiments, nanotubes of the dental implant preserve crestal bone or reduce bone loss.

In some embodiments, nanotubes of the dental implant provide or facilities the anti-bacterial properties to the dental implant system. In some cases, such nanotubes lower staph adhesion. In some cases, nanotubes with a diameter range of about 100 nm to about 150 nm reduce bacterial adhesion of biofilms.

In some embodiments, nanotubes of the dental implant system reduce or eliminate the macrophage and inflammatory response induced by the dental implant procedure or occurred in the dental implant area and its surrounding areas of the implant recipient. In some cases, the nanotubes decreases or suppresses macrophage activation in the dental implant area and its surrounding areas of the implant recipient. In some cases, nanotubes of the dental implant system generate or facilitate quenching of oxygen free radicals during or after the dental implant procedure or in the dental implant area and its surrounding areas of the implant recipient. In some cases, nanotubes of the dental implant system decreases or eliminate TNF alpha cytokine expression during or after the dental implant procedure, or TNF alpha cytokine expression in the dental implant area and its surrounding areas of the implant recipient. In some cases, nanotubes of the dental implant system causes or facilitate reduction in nitric oxide (NO) during or after the dental implant procedure, or in the dental implant area and its surrounding areas of the implant recipient.

In some cases, nanotubes of the dental implant system provide one or more benefit that is unique and untraditional. In further cases, such unique benefits include one or more selected from: biocompatibility, hydrophilic surface, enable tissue in-growth to hollow nanotubes, micron smooth surface (not rough at touch like traditional implant options), reduced infection to soft tissue, reduced infection to hard tissue, reduced bone loss, reduced soft tissue loss, increased soft tissue adhesion to implant, increased hard tissue or bone adhesion to implant, reduced inflammation to hard tissue, reduced inflammation to soft tissue, reduced bacterial aggregation near or at the implantation site, increased surface area for tissue adhesion. In some embodiments, nanotubes of the dental implant system enable collagen fibers, for non-limiting examples, PDLs or sharpeys fibers) to run perpendicular to the abutment. In some embodiments, nanotubes of the dental implant system enable in-growth of soft tissue into the nanotubes. In some cases, nanotubes of the dental implant system enable tissue to grow parallel to the abutment. In some cases, nanotubes of the dental implant system enable tissue to grow in one or more arbitrary directions with respect to the abutment or to the longitudinal axis of the implant body. In some embodiments, the nanotubes of the dental implant system alone or in combination with elements delivered via element(s) of the dental implant system stimulate cell differentiation or cell growth. In some embodiments, nanotubes enable tissue adhesion as shown in a gingival fibroblast. The connective tissue around a dental implant system is characterized by collagen fibers mostly aligned parallel to the implant surface. The collagen, glycoproteins, and other connective tissue matrix, are produced by gingival fibroblasts. Therefore, the biological response of gingival fibroblasts is the indication of success of the soft tissue around the implant. The epithelial tissue, the underlying fibrous connective tissue, and the attachment of the connective tissue to the implant are critical for separating the implant-bone interface from the oral environment.

In some cases, nanotubes of the dental implant system can be easily manufactured and scalable, thus, they can be applied on any 3D geometry and shape. In some cases, a nanotube of the dental implant system includes an increased surface area than a traditional implant system. In further cases, the traditional implant system is of substantially similar shape and dimension. In some cases, nanotubes of the dental implant system include one or more reservoir. In further cases, such reservoir can be loaded with drug, protein, or other materials for delivery. In some cases, nanotubes of the dental implant system include one or more hollow spaces for tissue in-growth. In some cases, nanotubes of the dental implant system can be combined with biologics and/or grafts to facilitate dental implantation. In some cases, a nanotube is tunable. In reference to nanotubes, tunable means the nanotube geometry is adjustable to the desired to geometry, size, spacing, and dimensions to elicit the desired tissue response. Studies have shown that small changes to the nanotube diameter can effect stem cell differentiation thus it is important to get the optimized geometry for enhanced tissue connection.

### Nanotube Surfaces and Structure

In some embodiments, the nanotubes of the dental implant system include a three-dimensional surface structure. In some cases, the nanotubes of the dental implant system includes patterned and arrays of nanotubes. In further cases, the pattern of nanotubes is substantially repetitive in one or more spatial dimensions. In further cases, an array of nanotubes is substantially similar to other arrays.

### Interfaces

In some embodiments, the dental implant device, system, or the manufacturing method as disclosed herein includes one or more interfaces. In some embodiments, the interfaces include nanotubes or nanotube arrays. In some embodiments, one or more element of the dental implant system includes an interface. The elements of the dental implant systems includes one or more selected from: the implant body, the abutment, the top collar of the implant body, the top screw of the implant body, the threads of the implant body, the threads of the abutment, the first coupling region, the second coupling region, the internal hex, the internal screw, the straight abutment region, the platform switching region, the cutting flute, the internal connections of the implant body, the internal connections of the abutment, the surface of the implant body, the surface of the abutment, the crown, and the surface of the crown. In some cases, the interface includes one or more structural elements to enable mechanical contact, physical contact, anchoring, attachment, abutment, or integration to one or more types of hard tissue and/or soft tissue. In further embodiments, the hard tissue includes one or more selected from: bone or tooth. In further embodiments, the soft tissue includes one or more selected from: gingiva, gum, mucosa, and fibroblast.

### Sizes and Dimensions

In some embodiments, nanotubes of the dental implant system as disclosed herein are patterned uniformly in arrays across the surface of both the implant and the abutment. In further embodiments, nanotubes are present on the threads and internal connection of the implant body. In some embodiments, nanotubes of the dental implant system as disclosed herein are on entire implant body and/or on entire abutment.

In some cases, nanotubes of the dental implant system as disclosed herein are of various dimensions and structures. In some embodiments, nanotubes of the dental implant system as disclosed herein include a diameter of about 10 nm to about 900 nm. In some embodiments, the diameter of the nanotubes is the vertical cross sectional diameter of the nanotubes. In some embodiments, the diameter of the nanotubes is the cross-sectional diameter with the cross-section being parallel to a surface of the abutment, the implant body, or both. In some embodiments, the diameter of the nanotubes is the cross-sectional diameter with the cross-section being perpendicular to the longitudinal axis of the nanotubes. In some cases, the longitudinal axis connects the two ends of the nanotubes. In some embodiments, nanotubes of the dental implant system as disclosed herein include a diameter of about 100 nm to about 150 nm. In some embodiments, nanotubes of the dental implant system as disclosed herein include a diameter of about 200 nm to about 500 nm. In some embodiments, nanotubes of the dental implant system as disclosed herein includes a height of about 10 nm to about 900 nm. In some embodiments, nanotubes of the dental implant system as disclosed herein includes a height of about 200 nm to about 800 nm. In some embodiments, the height is along an axis parallel to the longitudinal axis of the nanotubes. In some embodiments, nanotubes of the dental implant system as disclosed herein includes a lateral spacing (or empty space) of about 1 nm to about 300 nm between each other. In some embodiments, nanotubes of the dental implant system as disclosed herein includes a lateral spacing (or empty space) of about 1 nm to about 1 micron between each other. In some embodiments, nanotubes of the dental implant system as disclosed herein include a diameter of about 1 nm to about 800 nm. In some embodiments, nanotubes of the dental implant system as disclosed herein include a height of about 1 nm to about 15 microns. In some embodiments, nanotubes of the dental implant system as disclosed herein includes a lateral spacing of about 1 nm to about 15 microns between each other. In some cases, the dimensions of nanotubes vary in ranges with numerous possible combinations based upon desired outcomes. In some embodiments, longer nanotube heights enable greater drug delivery potential.

In some embodiments, the diameter of the nanotube ranges from about 90 nm to about 150 nm. In some embodiments, the cross-sectional diameter of the nanotube ranges from about 90 nm to about 150 nm. In some embodiments, the diameter of the nanotube ranges from about 1 nm to about 999 nm. In some embodiments, the cross-sectional diameter of the nanotube ranges from about 1 nm to about 999 nm. In some embodiments, the diameter of the nanotube ranges from about 10 nm to about 10 microns. In some embodiments, the cross-sectional diameter of the nanotube ranges from about 10 nm to about 10 microns. In some embodiments, the diameter of the nanotube ranges from about 1 nm to about 20 microns. In some embodiments, the cross-sectional diameter of the nanotube ranges from about 1 nm to about 20 microns nm. In some embodiments, the diameter of the nanotubes is the average diameter, the median diameter, the maximal diameter, or the minimal diameter of the nanotubes of one or more nanotube arrays. In some embodiments, the height of the nanotubes is the average, the median, the maximal, or the minimal height of the nanotubes of one or more nanotube arrays. In some embodiments, the lateral spacing of the nanotubes is the average, the median, the maximal, or the minimal lateral spacing of the nanotubes of one or more nanotube arrays. In some embodiments, the width or length of the empty spaces between nanotubes is the average, the median, the maximal, or the minimal width or length of the nanotubes of one or more nanotube arrays. In some embodiments, the later spacing and the width or length of the empty spaces are equivalent and interchangeable herein. In some embodiments, the height of the nanotube ranges from about 200 nm to about 400 nm. In some embodiments, the height of the nanotube ranges from about 1 nm to about 999 nm. In some embodiments, the height of the nanotube ranges from about 300 nm to about 10 microns.

In some embodiments, the distance between the cross-sectional centers of two adjacent nanotubes ranges from about 100 nm to about 200 nm. In some embodiments, the lateral spacing of two adjacent nanotubes ranges from about 100 nm to about 200 nm. In some embodiments, the distance between the cross-sectional centers of two adjacent nanotubes ranges from about 10 nm to about 500 nm. In some embodiments, the lateral spacing of two adjacent nanotubes ranges from about 10 nm to about 500 nm. In some embodiments, the diameter of the nanotubes is the average diameter, the mean diameter, the maximal diameter, or the minimal diameter of nanotubes of one or more nanotube arrays.

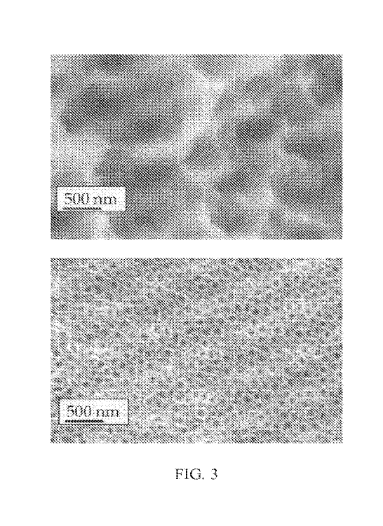

Referring to FIG. 3, in a particular embodiment, is a non-limiting example surface of the dental implant system as disclosed herein with 100 nm diameter TiO2 nanotube arrays. In this embodiments, the top view of the nanotube arrays (bottom panel) shows nano pore size that is about 100 times smaller than traditional micron pores (top panel). In this particular embodiment, one or more selected from: the small nano pore size, the spacing between nano tubes, and the opening of nano pores are beneficial to the antibacterial and/or anti-inflammation property of the nanotube array-coated dental implant systems. In the same embodiments, the empty spacing between nanotubes, and the open ends of the nanotubes (surrounded by a substantially circular tube wall) facilitate the tissue integration to the hard tissue, soft tissue or both in the vicinity thereof.

In some embodiments, the nanotubes have a longer height, for non-limiting example, a height of greater than about 1 micron, near the top collar and abutment connection region. In further cases, such longer height promotes tissue adhesion, healing, or drug delivery capabilities. In alternative cases, the nanotubes have shorter, for non-limiting example, a height of less than about 300 nm, on the implant body to promote structural integrity during implant placement.

In some embodiments, of the dental implant system as disclosed herein are patterned with different dimensions. In further embodiments, such dimensions include one or more selected from: a height, a diameter, a cross-sectional area, a lateral distance between two adjacent nanotubes, a lateral distance between two most-adjacent nanotubes, an array size, an array length, and an array width. In some cases, such different dimensions are provided on the surface of either or both the implant body and abutment in preselected patterns of tube size, height, intertube-spacing such that they promote different biological responses.

### Locations of the Nanotubes

In some embodiments, nanotubes or nanotube arrays of the dental implant system as disclosed herein are located at least partly on an implant body. In some embodiments, nanotubes or nanotube arrays of the dental implant system as disclosed herein are at least partly on abutment. In some embodiments, the nanotubes or nanotube arrays are at least at substantially the entire surface of one or more selected from: the implant body, the abutment, the top collar of the implant body, the top screw of the implant body, the threads of the implant body, the threads of the abutment, the first coupling region, the second coupling region, the internal hex, the internal screw, the straight abutment region, the platform switching region, the cutting flute, the internal connections of the implant body, the internal connections of the abutment, the surface of the implant body, the surface of the abutment, the crown, and the surface of the crown. In some embodiments, the nanotubes or nanotube arrays are at least partly located on one more selected from: the implant body, the abutment, the top collar of the implant body, the top screw of the implant body, the threads of the implant body, the threads of the abutment, the first coupling region, the second coupling region, the internal hex, the internal screw, the straight abutment region, the platform switching region, the cutting flute, the internal connections of the implant body, the internal connections of the abutment, the surface of the implant body, the surface of the abutment, the crown, and the surface of the crown. In some embodiments, the nanotubes or nanotube arrays covers a portion of the surface or the volume of one more selected from: the implant body, the abutment, the top collar of the implant body, the top screw of the implant body, the threads of the implant body, the threads of the abutment, the first coupling region, the second coupling region, the internal hex, the internal screw, the straight abutment region, the platform switching region, the cutting flute, the internal connections of the implant body, the internal connections of the abutment, the surface of the implant body, the surface of the abutment, the crown, and the surface of the crown. In some embodiments, the portion of surface or volume covered is in the range of about 1% to about 99%.

In some embodiments, nanotubes or nanotube arrays of the dental implant system as disclosed herein are not on an implant body or a crown. In some embodiments, nanotubes of the dental implant system as disclosed herein are not on an abutment. In some embodiments, nanotubes or nanotube arrays are on top of one or more existing surfaces of the implant, the abutment, or both to create multi-surface topographies. In some embodiments, masking techniques can be utilized to place nanotubes only on certain predetermined regions of the implant body, the abutment, or both. In some embodiments, the predetermined region of the implant body is near the top collar. In some embodiments, the predetermined region of the implant body is not the main implant body below the top collar. In one embodiment, the predetermined region of the abutment is on the lower part of the abutment that is in contact with the implant. In some embodiments, the predetermined region of the implant body is not on the top part that is in contact with the crown.

### Manufacturing Processes

In some embodiments, the manufacturing process or method of nanotubes as disclosed herein includes one or more equipment selected from: a fume hood for anodization, a voltage meter power supply to apply 20 volts voltage, a Platinum electrode, a cathode in solution, a plastic container to hold solution while anodizing, a pressurized air to wash samples, an ultrasonicator to wash samples, a furnace to heat treat, a tube furnace. In some embodiments, the manufacturing process or methods of nanotubes as disclosed herein include one or more chemicals selected from: acetic acid, nitric acid, deionized water, and hydrofluoric acid (HF).

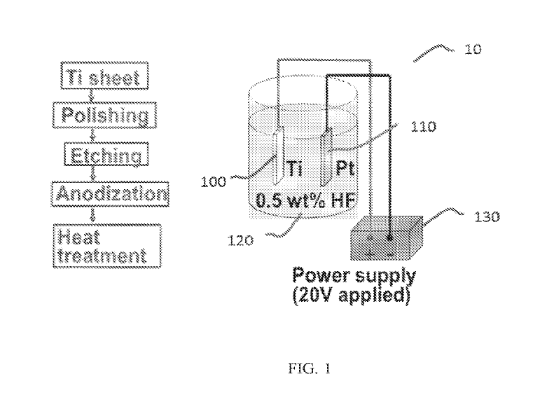

Referring to FIG. 1, in a particular embodiment, an electrochemical anodization system 10 is set up using a sheet of Ti as the negative electrode/anode 100 and Pt as the positive electrode/cathode 120 in a hydrofluoric acid (HF) electrolyte solution 110. In this particular embodiment with two-electrode setup, titanium serves as anode 100 and platinum as cathode 110. The electrolyte is a solution with 0.5 wt % HF. A constant direct current (DC) voltage 130 is applied across the electrodes. After applying the power for a certain period of time, a layer of TiO2 nanotube arrays form on the surface of Ti metal. In other embodiments, the sheet of Ti in the anodization system 10 is replaced with one or more other sheet of metal, metal oxide, alloy, alloy oxide, or polymer. In alternative embodiments, the sheet of Ti in in the anodization system 10 is replaced by one or more elements or parts of the dental implant system. In further embodiments, each element includes the abutment or the implant body.

In some embodiments, the manufacturing process or method of nanotubes as disclosed herein includes an anodization process. In some embodiments, the manufacturing process or method of nanotubes as disclosed herein includes a heat-treating process. In further embodiments, the manufacturing process or method of nanotubes as disclosed herein includes an anodization process and a heat-treating process on various metals or alloys. In some embodiments, such metal or alloys includes one or more selected from but not limited to: Ti, Ta, Hf, Zr, Nb, W, TiAlNb, TiNb, and TiZr. In some embodiments, the anodization process and the heat-treating process includes a polymer. In further embodiments, a thin layer of metal or alloy is placed (for non-limiting examples, Titanium, or Tantalum) on the selected polymer, and the anodization process and heat-treating process are carried out on the metal or alloy-coated polymer

In some embodiments, a manufacturing process using Titanium includes connecting Platinum cathode to a power supply. In some embodiments, Ti is the anode. In further embodiments, the manufacturing process or method as disclosed herein includes a HF solution of about 0.5% by weight of HF in water. In some embodiments, 1 liter of solution includes 866 ml of water, 9 ml of 48% HF, and 125 ml of acetic acid. In some embodiments, a manufacturing process using Titanium includes anodization. In further embodiments, the anodization process includes one or more steps selected from: cleaning Ti with acetone, cleaning Ti with isopropanol, cleaning Ti with water, connecting Ti and Pt to negative and positive electrodes, placing Ti and Pt in HF solution, turning on the power source (20V for 100 nm diameter), leaving for 30 min at room temperature, removing from acid bath, washing thoroughly with water, blow drying with air to remove any visible liquid, drying in oven of about 200 degrees Celsius for about 3 to 4 hours until the sample is completely, placing in furnace for heat treatment, controlling heating rate at 1 degree Celsius per minute till the temperature reaches 500 degrees Celsius, maintaining the temperature of the implant body, abutment, or healing abutment at a temperature of 500 degrees Celsius for at least 2 hours, and cooling at a controlled cooling rate.

In some embodiments, a manufacturing process using Niobium includes connecting Platinum cathode to a power supply. In some embodiments, Nb is the anode. In some embodiments, a manufacturing process using Nb includes anodization. In further embodiments, the anodization process includes one or more steps selected from: cleaning Nb with acetone, cleaning Nb with isopropanol, cleaning Nb with water, connecting Nb and Pt to negative and positive electrodes, placing Nb and Pt in HF solution, placing Nb and Pt in 1 M H₂SO₄ with HF, turning on the power source (20V for 100 nm diameter), leaving for 30 min at room temperature, removing from acid bath, washing thoroughly with water, blow drying with air to remove any visible liquid, drying in oven of about 200 degrees Celsius for about 3 to 4 hours until the sample is completely, placing in furnace for heat treatment, controlling heating rate so that the implant sample is maintained at a temperature of 500 degrees Celsius for 2 hours. In some embodiments, the Nb used in the manufacturing process or method as disclosed herein includes a foil with a thickness of about 0.1 mm. In some embodiments, the surface of the specimen is cleaned ultrasonically with ethanol, distilled water, and dried with Ar. In some embodiments, the manufacturing process or method as disclosed herein includes ramping up the voltage to 20 volts.

In some embodiments, a manufacturing process uses Tantalum. In some cases, Tantalum films of purity above 99%, as a non-limiting example, at 99.9% purity, are degreased by sonicating in acetone, isopropanol and methanol. In some cases, the Tantalum films are then rinsed with deionized water and dried in a nitrogen stream. In some embodiments, the samples are anodized in glycerol with different amounts of NH₄F. In some embodiments, all electrolytes were prepared from reagent grade chemicals. In some embodiments, the structure and morphology of the films were characterized using a field-emission scanning electron microscope. In some embodiments, Cross-sectional thickness measurements are carried out directly on mechanically cracked samples.

In some embodiments, a manufacturing process for generating nanotubes uses ZrO₂. In some cases, ZrO2 nanotube surfaces are created using a two-step electro-chemical anodization process in order to create a more ordered final nanotube structure. In some cases, the zirconium foil (as a non-limiting example, thickness of about 0.25 mm and purity of about 99.8%) is first cleaned by rinsing in acetone, isopropanol, and distilled water, and finally air dried. In some cases, anodization is performed using a two-electrode-setup consisting of a platinum electrode (as a non-limiting example, thickness, 0.1 mm and purity of 99.99%) as the cathode, and the zirconium foil as the anode. In some embodiments, the first anodization step is performed using 0.75 mol/l ammonium fluoride in 1 mol/l ammonium sulfate in deionized water at 20 V for 30 min at room temperature. In some embodiments, the first anodization layer is thoroughly removed by peeling away with adhesive tape, followed by 30 min of ultrasonic cleaning in an acetone bath. In some embodiments, the second anodization step is performed using 0.15 mol/l ammonium fluoride in 1 mol/l ammonium sulfate in deionized water at 20 V for 15 min at room temperature. In some cases, the samples are then washed with deionized water, dried at 80 degrees Celsius and heat treated at 300 degrees Celsius for 6 hours in order to reduce residual fluorides, or to crystallize the as-fabricated amorphous structured ZrO2 nanotubes into a mixed crystalline structure of monoclinic baddeleyite ZrO2 and tetragonal ZrO2. In some embodiments, a manufacturing process using ZrO₂ creates highly ordered vertically aligned nanotubes with a pore size of roughly 40 nm, and a length of 10 μm.

In alternative embodiments, the samples of Zr foil are rinsed and sonicated in isopropyl alcohol. Then it is dried in a nitrogen stream and immersed in solution. In some cases, the foil samples are anodized in 0.5 wt % HF solution at 10 V for 1 to 10 min by using Pt wire as counter electrode. In some cases, the samples receive heat treatment at 300 degrees Celsius for 6 hour to insure fluorine removal from the ZrO2 nanotubes. In some embodiments, Nanotubes are ca. 20 nm in diameter and ca. 5 nm in wall thickness, and are uniformly distributed on the surface in a regular pattern that resembles porous aluminum oxide.

In some embodiments, a manufacturing process for generating nanotubes includes step of pretreatment (as a non-limiting example, dip-etching for about 1 s) of the Zr metal in a solution containing HF/HNO₃/H₂O (1:4:2) prior to anodization. In some embodiments, a manufacturing process for generating nanotubes includes a first anodization step that is conducted in 1 M (NH₄)₂SO₄ electrolyte containing 0.75 M NH₄F at 20 V for 30 min. In some embodiments, the obtained layers are then removed through ultrasonication in ethanol. The removal of the first nanotubular oxide layer results in a surface showing ordered dimples of regular size and distribution. In some embodiments, a manufacturing process for generating nanotubes includes a second anodization, 1 M (NH₄)₂SO₄ containing 0.15 M NH₄F (as aqueous/inorganic electrolyte) at 20 V for 60 min.

In some embodiments, a manufacturing process for generating nanotubes includes step of pretreatment (as a non-limiting example, dip-etching for about 1 s) of the Zr metal in a solution containing HF/HNO₃/H₂O (1:4:2) prior to anodization. In some embodiments, a manufacturing process for generating nanotubes includes a first anodization step that is conducted in 1 M (NH₄)₂SO₄ electrolyte containing 0.75 M NH₄F at 20 V for 30 min. In some embodiments, the obtained layers are then removed through ultrasonication in ethanol. The removal of the first nanotubular oxide layer results in a surface showing ordered dimples of regular size and distribution. In some embodiments, a manufacturing process for generating nanotubes includes a second anodization process, in ethylene glycol/glycerol (50:50) mixed electrolyte containing 0.3 M NH₄F and 4 vol % H₂O (or 4% in volume)((organic electrolyte) at 20 Volts for 60 min.

In some embodiments, the Ti nanotubes are manufactured in a larger scale defined as any configuration that would allow for more than one implant anodization. It could be more than 1 up to hundreds depending on the size of the acid bath and number of connections to the power supply. In some embodiments, the Platinum cathode is connected to power supply in a large scale manufacturing process. In some embodiments, the large scale manufacturing process includes a HF solution (for a non-limiting example, 0.5% by weight of HF in water). In some embodiments, a large scale manufacturing process includes a cleaning solution HF:HNO₃ of 1:1 diluted in water. In further embodiments, the manufacturing process or method as disclosed herein includes an electrolyte solution with about 0.5% by weight of HF in water. In some embodiments, 1 liter of the electrolyte solution includes 866 ml of water, 9 ml of 48% HF, and 125 ml of acetic acid. In further embodiments, the cleaning solution includes HF, HNO3, H2O, and V (HF):V(HNO3):V(H2O) is about 1:1:40 to about 1:1:60. In some embodiments, the large scale manufacturing process includes an anodization process. In further embodiments, the anodization process includes washing Ti with acetone for about 1 minute to about 5 minutes. This is to remove any residual manufacturing debris or solution. Specifically for all the washing steps in large scale manufacturing, in some cases, all the implants in that specific lot can be placed in some type of tray or bath to wash the implants together. In further embodiments, the anodization process includes washing the Ti implant to clean and remove any particulate that may be left over from the Swiss machining of the implant with isopropanol. This is to remove any residual manufacturing debris or solution. In further embodiments, the anodization process includes washing Ti with water. This is to remove any residual manufacturing debris or solution. In further embodiments, the anodization process includes a pre-heating treatment. The pre-heating treatment is to remove residual surface stress created from manufacturing. In some embodiments, Titanium implants are chemically polished in cleaning solution for about 5 minutes to about 10 minutes to remove the native oxide layer. In some cases, during anodization the current without chemical polishing is higher than with chemical polishing, this may lead to failure of uniform nanostructure. In some cases, the manufacturing process or method as disclosed herein includes ultrasonic washing with water before anodization to remove the residual cleaning solution. In some embodiments, the manufacturing process or method includes connecting Ti and Pt to negative and positive electrodes, respectively. In some cases, several Ti implants can be anodized together as long as the Pt surface area is substantially equal to Ti surface area and the electrolyte solution ratio is increased proportionally at a predetermined rate. In some cases, the manufacturing process or method as disclosed herein includes a HF solution of about 0.5% by weight of HF in water. In some embodiments, 1 liter of solution includes 866 ml of water, 9 ml of 48% HF, and 125 ml of acetic acid. In some embodiments, the electrolyte solution is under mixing to ensure uniform distribution of electrolytes. In some cases, the manufacturing process or method as disclosed herein includes turning on a power source (20V for 100 nm diameter). In some cases, the manufacturing process or method includes leaving the sample of implant for 30 min at room temperature. In some cases, the manufacturing process or method includes removing the sample of implant from acid bath. In some cases, the manufacturing process or method includes washing thoroughly with water. In some cases, the manufacturing process or method includes ultrasonicating to remove any residual solution. In some cases, the manufacturing process or method includes blowing dry with air to remove any visible liquid. In some cases, the manufacturing process or method as disclosed herein includes drying in oven. In some cases, the manufacturing process or method includes placing in furnace for heat treatment. In further embodiments, the heating rate is controlled to be in a predetermined range. In further embodiments, the heating temperature is held at about 500 degrees Celsius for at least 2 hours. In further embodiments, cooling after heating is at a controlled cooling rate.

In some embodiments, the manufacturing process or method as disclosed herein includes a TiArray surface modification process including one or more selected from: cleaning, anodization, washing, drying, and heat treatment procedures. In some embodiments, TiArray surface modification process uses one or more equipment selected from but not limited to: a power supply, a ultrasonicator, Copper alligator clips, Platinum (Pt) cathode, hydrofluoric acid, Nitric acid, a 1 liter container, a 5 liter or larger waster container, 250 mL anodization container with acid bath, 250 mL wash container, deionized water, isopropanol, acetone, furnace with control console, ceramic furnace fixture, gloves, goggles, lab coat, forceps, and tongs. In some embodiments, the TiArray surface modification process includes a cleaning solution containing a mixture of HF and HNO. In some embodiments, TiArray surface modification process includes washing implant with acetone for 5 minutes. In some embodiments, TiArray surface modification process includes washing implant with isopropanol for 5 minutes. In some embodiments, TiArray surface modification process includes washing implant with water for 5 minutes. In some embodiments, TiArray surface modification process includes washing implant with cleaning solution for 1 minute. In some embodiments, TiArray surface modification process includes ultrasonic washing with water before anodization. In some embodiments, TiArray surface modification process includes connecting Platinum cathode (Ti as anode) to a voltage controlled power supply. In some embodiments, TiArray surface modification process includes an electrolyte solution (0.5% by weight of HF in water). In some embodiments, TiArray surface modification process includes an anodization procedure with one or more steps selected from: connecting implant and Pt to negative and positive electrodes; placing implant in electrolyte solution; turning on power source; remaining at room temperature; and removing from electrolyte bath after 30 minutes.

In some embodiments, TiArray surface modification process includes rising implant individually with deionized water after the anodization procedure. In some embodiments, TiArray surface modification process includes ultrasonic wash of implant in deionized water after the anodization procedure.

In some embodiments, TiArray surface modification process includes a drying step after the anodization and washing steps. In further embodiments, the drying step includes placing the implant in furnace at about 200 degrees Celsius on drying rack fixture to dry for at least 1 hour.

In some embodiments, TiArray surface modification process includes a heat-treatment step after the drying step. In further embodiments, the heat-treatment step includes one or more selected from: checking heating settings for heat treatment cycle; placing implants in furnace fixturing; placing furnace for about 500 degree Celsius heat treatment cycle; carefully removing from furnace using tongs after cycle completion; and placing the implant on cooling rack to allow implants to cool before packaging.

In some embodiments, nanotube arrays are located on different surfaces of the implant body or the abutment with various surface roughness. In some embodiments, the methods, systems, or devices as disclosed herein include a surface that is compatible to include nanotube arrays thereon. In further embodiments, the surface is selected from one or more selected from: a machined surface, a polished surface, an etched surface, a grit-blasted surface, a SLA (sand-blasted and acid-etched) surface, a pitted surface, a surface with different roughness, a smooth, a moderately rough surface, a rough surface, and a porous surface with pore size of up to trabecular pore sizes. In some embodiments, the nanotube arrays and a surface are configured to create multi-surfaces combining the nanotube arrays with one or more surfaces as listed above.

Various embodiments of the nanotubes or nanotube arrays described in the related U.S. patent application Ser. No. 13/858,042, U.S. application Ser. No. 11/913,062, U.S. application Ser. No. 13/176,907, U.S. application Ser. No. 12/900,249, and U.S. application Ser. No. 12/305,887, and PCT application No. PCT/US2006/016471, all of the above identified applications previously mentioned are incorporated herein by reference.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

Unless otherwise defined, all technical terms used herein have the same meaning as commonly understood by one of ordinary skill in the art. As used in this specification and the appended claims, the singular forms “a,” “an,” and “the” include plural references unless the context clearly dictates otherwise. Any reference to “or” herein is intended to encompass “and/or” unless otherwise stated. As used in this specification and the claims, unless otherwise stated, the term “about” refers to variations of +/−1%, +/−2%, +/−3%, +/−4%, +/−5%, +/−6%, +/−7%, +/−8%, +/−9%, +/−10%, +/−11%, +/−12%, +/−14%, +/−15%, +/−16%, +/−17%, +/−18%, +/−19%, +/−20%, +/−22%, or +/−25%, depending on the embodiment. As a non-limiting example, about 100 meter represents a range of 95 meters to 105 meters, 90 meters to 110 meters, or 85 meters to 115 meters depending on the embodiments.

While preferred embodiments have been shown and described herein, it will be obvious to those skilled in the art that such embodiments are provided by way of example only. Numerous variations, changes, and substitutions will now occur to those skilled in the art without departing from what have been disclosed herein. It should be understood that various alternatives to the embodiments, of what have been described herein may be employed in practicing what have been disclosed herein. It is intended that the following claims define the scope and that methods and structures within the scope of these claims and their equivalents be covered thereby.

1. A biocompatible dental implant system, comprising:
an implant body comprising a top collar; and
an abutment comprising a first coupling region and a second coupling region, wherein the first coupling region is mechanically coupled to the top collar, and the second coupling region is mechanically coupled to a crown, and wherein at least a portion of a surface of the abutment includes one or more nanotube arrays, the one or more nanotube arrays comprising a plurality of nanotubes separated by a plurality of empty spaces.

2. The system of claim 1, wherein each of the plurality of nanotubes comprises:
a tubular wall;
at least two ends; and
a hollow inner space located between the at least two ends and enclosed by the tubular wall.

3. The system of claim 2, wherein the tubular wall comprises one or more selected from: a metal, a metal oxide, an alloy, an alloy oxide, and a polymer.

4. The system of claim 2, wherein the tubular wall comprises one or more selected from: Ti, Ta, Hf, Zr, Nb, W, TiAlNb, TiNb, TiZr, and PEEK.

5. The system of claim 2, wherein the tubular wall has a wall thickness of about 0.1 nm to about 1 micron.

6. The system of claim 2, wherein the tubular wall is substantially vertical to a surface plane of the implant body, the abutment, or both.

7. The system of claim 2, wherein the hollow inner space is configured to hold one or more biocompatible material, to release one or more biocompatible material, or both.

8. The system of claim 2, wherein the hollow inner space is configured to allow cell growth.

9. The system of claim 2, wherein a depth of the tubular wall vertical to the surface plane of the implant body, the abutment, or both is in a range of about 1 nm to about 10 microns.

10. The system of claim 1, wherein the one or more nanotube arrays are configured to directly contact at least a soft tissue when the biocompatible dental implant system is properly implanted.

11. The system of claim 6, wherein the plurality of nanotubes and the plurality of empty spaces are aligned in a repetitive pattern.

12. The system of claim 11, wherein the repetitive pattern occurs in a plane vertical to the surface plane of the implant body, the abutment, or both.

13. The system of claim 11, wherein the repetitive pattern occurs in two dimensions or three dimensions.

14-15. (canceled)

16. The system of claim 1, wherein a diameter of a horizontal cross-sectional area of each of the plurality of nanotubes is in a range of about 1 nm to about 1 micron.

17. The system of claim 1, wherein a width and length in a horizontal direction of each of the plurality of empty spaces is in a range of about 1 nm to about 1 micron.

18. (canceled)

19. The system of claim 1, wherein the one or more nanotube arrays are on a top surface of a polymer layer of the abutment.

20-22. (canceled)

23. The system of claim 1, wherein the implant body is tapered and is configured to enable platform switching.

24-26. (canceled)

27. The system of claim 1, wherein the one or more nanotube arrays are generated via an anodization process of one or more selected from: a metal, a metal oxide, an alloy, an alloy oxide, and a polymer.

28. The system of claim 27, wherein the anodization process includes a heat-treating process.

29-36. (canceled)

37. A method of manufacturing a biocompatible dental implant system, comprising:
a) anodizing a sample in a predetermined electrolyte solution, generating an anodized sample, the anodizing comprising:
i) connecting the sample to a negative electrode,
ii) connecting Platinum to a positive electrode,
iii) placing the positive and negative electrodes in the predetermined electrolyte solution,
iv) connecting the positive and negative electrodes to a power supply, and
v) turning on the power supply; and
b) heat-treating the anodized sample, generating a processed sample comprising a plurality of nanotubes separated by a plurality of empty spaces.

38-79. (canceled)
